(19) United States
(12) Patent Application Publication
(10) Pub. No.: US 2009/0266461 A1
(43) Pub. Date: Oct. 29, 2009

(54) RUBBER COMPOSITE AND TIRES MADE BY USING THE SAME

(75) Inventors: Uchu Mukai, Tokyo (JP); Kazuhiko Misumi, Tokyo (JP); Takashi Shimada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Chuo-ku ,Tokyo (JP)

(21) Appl. No.: 12/439,709

(22) PCT Filed: Aug. 2, 2007
(86) PCT No.: PCT/JP2007/065182

§ 371 Date: Mar. 3, 2009

(30) Foreign Application Priority Data
Sep. 8, 2006 (JP) 2006-244806

(51) Int. Cl. B60C 5/00; C08K 3/22; C08K 5/24

(52) U.S. Cl. 152/450; 524/432; 524/189

(57) ABSTRACT

The present invention provides a rubber composite constituted of at least two layers of members comprising a rubber composition containing a diene base rubber cross-linked by sulfur, wherein a difference in a concentration of sulfur between adjacent members in the rubber composite described above is 1.5 part by mass or more based on 100 parts by mass of a rubber component in the rubber composition described above; zinc oxide is blended in an amount satisfying a condition shown in the following equation (I) based on 100 parts by mass of a rubber component in a low sulfur concentration rubber composition among the adjacent members, and an antioxidant and/or a naphthoic hydrazide compound are blended in an amount satisfying a condition shown in the following equation (II) based on 100 parts by mass of the rubber component in the low sulfur concentration rubber composition:

blending amount (parts by mass) of zinc oxide in the low sulfur concentration rubber composition>Sb×1.3+(Sa−Sb)×0.3 (I)

(wherein Sa represents a blending amount (parts by mass) of sulfur in the high sulfur concentration rubber composition, and Sb represents a blending amount (parts by mass) of sulfur in the low sulfur concentration rubber composition) and

blending amount (mole) of the antioxidant and/or the naphthoic hydrazide compound in the low sulfur concentration rubber composition>0.005+(Sa−Sb)/2000 (II)

(wherein Sa and Sb represent the same contents as described in the equation (I)); a rubber composite improved in a problem originating in a difference in a concentration of a blending agent, particularly sulfur between adjacent rubber compositions comprising a rubber composition cross-linked by sulfur without using new raw materials and members; and a tire prepared by using the same.

### BACKGROUND OF THE INVENTION

The present invention relates to a composite of a rubber composition comprising a diene base rubber cross-linked by sulfur, more specifically to a rubber composite improved in a problem originating in a difference in concentrations of blending agents in adjacent rubber compositions constituting the composite and a tire prepared by using the same.

### RELATED ART

In a composite constituted by rubber compositions which are used for tires and have different blend contents, usually when a difference in concentrations of materials such as blended chemicals and the like is brought about, diffusion and transfer thereof take place so that a difference in the concentrations is decreased. As a result thereof, a rubber composition in the vicinity of an interface between members deviates from a blend composition which is initially set, and the expected characteristics can not be exhibited in a certain case. In particular, the crack growth potential and the adhesive property are reduced to result in bringing about troubles in a durability of a tire.

For example, when a difference in a concentration of sulfur is caused between adjacent members, sulfur is transferred from a high sulfur-blended rubber to a low sulfur-blended rubber, and a larger blend amount of sulfur than a set blend amount thereof is present in the low sulfur-blended rubber in the vicinity of an interface. As a result thereof, a balance of a cross-linking agent is broken in the vicinity of an interface, and expected characteristics which are initially set can not be exhibited.

A specific problem caused by the difference in the concentration described above is brought about between a coating rubber for burying a steel cord and an adjacent rubber thereof, and many investigations are made as an improving method therefor (refer to, for example, patent documents 1 to 2).

A deterioration in adhesion of a steel coating rubber with a steel cord which is caused by heat is considered to be attributable to that an adhesion layer comprising copper sulfide which is heated is reacted with zinc eluting from a plating to form a layer of zinc sulfide in the adhesion layer and that the adhesive force is reduced. It is considered that in order to enhance a heat resistant life in adhesion, copper sulfide is inhibited from being broken to prevent zinc from eluting. In order to achieve the above matter, it is considered to be effective to blend sulfur in a large amount.

When sulfur is blended in a large amount in order to enhance a heat resistant life in adhesion of a steel cord with a coating rubber therefor, a fracture property, particularly a heat resistant deterioration property is worsened.

On the other hand, sulfur is transferred to an adjacent member during vulcanization due to a difference in a sulfur blending amount from that of the adjacent member, and it is meaningless to increase a sulfur amount of a coating rubber in order to enhance a heat resistant life in adhesion with a steel cord. On the contrary, a heat resistance of the adjacent member is reduced as well. However, in order to enhance a heat resistant life in adhesion of a steel cord with a coating rubber, it is an essential condition to blend sulfur in a large amount, and sulfur is blended usually in an amount of 5 to 10 parts by mass in terms of a sulfur content based on 100 parts by mass of a rubber component.

Disclosed in the patent document 1 are large-sized tires for a heavy load and off-road tires in which a cushion rubber adjacent to a carcass layer and a belt layer is blended with prescribed polysulfide to inhibit sulfur from transferring from a coating rubber to thereby solve inferior adhesion of a steel cord with the coating rubber in the carcass layer and the belt layer of the tire and enhance a durability and a failure time of the tire.

Further, disclosed in the patent document 2 are a rubber composition in which 40 to 70 parts by weight of carbon black, 0.1 to 3.0 parts by weight of an organic acid cobalt salt and to 10 parts by weight of the total sulfur component including sulfur and a silane coupling agent containing specific sulfur based on 100 parts by weight of a rubber component in a rubber composition are contained to thereby allow a heat resistance to a fracture property of rubber to be compatible with a heat resistance to adhesion and tires.

In the techniques disclosed in the above patent documents, the purposes described above can be achieved by inhibiting sulfur from being transferred to adjacent members, but specific members and raw materials have to be used, and problems in terms of costs and administration are left.

Accordingly, a difference brought about between characteristics in a central part of a member in a rubber composite and characteristics in the vicinity of an interface to other adjacent members has to be controlled as much as possible without using specific new raw materials and members.

Patent document 1: Japanese Patent Application Laid-Open No. 67358/2005
Patent document 2: Japanese Patent Application Laid-Open No. 75888/2005

### DISCLOSURE OF THE INVENTION

An object of the present invention is to provide a rubber composite improved in a problem originating in a difference in a concentration of a blending agent, particularly sulfur in adjacent rubber compositions comprising a rubber composition containing a diene base rubber cross-linked by sulfur without using new raw materials and members and a tire prepared by using the same.

Intensive researches repeated by the present inventors in order to achieve the object described above have resulted in finding that the above object can be achieved by blending zinc oxide, and an antioxidant and/or a naphthoic hydrazide compound in amounts obtained by specific relational equations into a low sulfur concentration rubber composition of a composite in which a difference in a sulfur concentration between adjacent members is a specific amount or more that is, blending zinc oxide, and the antioxidant and/or the naphthoic hydrazide compound in advance into the low sulfur concentration rubber composition by estimating an amount of sulfur after transferred to a low sulfur concentration composition side. The present invention has been completed based on the above knowledge.

That is, the present invention provides a rubber composite constituted of at least two layers of members comprising a rubber composition containing a diene base rubber cross-linked by sulfur, wherein a difference in a concentration of sulfur between adjacent members in the rubber composite described above is 1.5 part by mass or more based on 100 parts by mass of a rubber component in the rubber composition; zinc oxide is blended in an amount satisfying a condition shown in the following equation (I) based on 100 parts by mass of a rubber component in a low sulfur concentration rubber composition among the adjacent members, and an antioxidant and/or a naphthoic hydrazide compound are blended in an amount satisfying a condition shown in the following equation (II) based on 100 parts by mass of the rubber component in the low sulfur concentration rubber composition:

blending amount (parts by mass) of zinc oxide in the low sulfur concentration rubber composition>Sb×1.3+(Sa−Sb)×0.3 (I)

(wherein Sa represents a blending amount (parts by mass) of sulfur in the high sulfur concentration rubber composition, and Sb represents a blending amount (parts by mass) of sulfur in the low sulfur concentration rubber composition) and

blending amount (mole) of the antioxidant and/or the naphthoic hydrazide compound in the low sulfur concentration rubber composition>0.005+(Sa−Sb)/2000 (II)

(wherein Sa and Sb represent the same contents as described in the equation (I)); and
a tire prepared by using the above rubber composite as a member which is not brought into direct contact with the ambient air.

### BEST MODE FOR CARRYING OUT THE INVENTION

First, the composite of the present invention is a rubber composite constituted of at least two layers of members comprising a rubber composition containing a diene base rubber cross-linked by sulfur, a difference in a concentration of sulfur between adjacent members in the rubber composite described above is 1.5 part by mass or more based on 100 parts by mass of a rubber component in the rubber composition; zinc oxide is blended in an amount satisfying a condition shown in the following equation (I) based on 100 parts by mass of a rubber component in a low sulfur concentration rubber composition among the adjacent members, and an antioxidant and/or a naphthoic hydrazide compound are blended in an amount satisfying a condition shown in the following equation (II) based on 100 parts by mass of the rubber component in the low sulfur concentration rubber composition:

blending amount (parts by mass) of zinc oxide in the low sulfur concentration rubber composition>Sb×1.3+(Sa−Sb)×0.3 (I)

(wherein Sa represents a blending amount (parts by mass) of sulfur in a high sulfur concentration rubber composition, and Sb represents a blending amount (parts by mass) of sulfur in the low sulfur concentration rubber composition) and

blending amount (mole) of the antioxidant and/or the naphthoic hydrazide compound in the low sulfur concentration rubber composition>0.005+(Sa−Sb)/2000 (II)

(wherein Sa and Sb represent the same contents as described in the equation (I)).

In this respect, “a blending amount (mole) of the antioxidant and/or the naphthoic hydrazide compound in the low sulfur concentration rubber composition” means a total blending amount thereof when both of the antioxidant and the naphthoic hydrazide compound are blended, a blending amount thereof when only the antioxidant is blended and a blending amount thereof when only the naphthoic hydrazide compound is blended.

In the present invention, a difference in a sulfur concentration between the adjacent members in the rubber composite has to be 1.5 part by mass or more based on 100 parts by mass of the rubber component in the rubber composition described above. If a difference in a sulfur concentration between the adjacent members in the rubber composite is 1.5 part by mass or more, sulfur is transferred from the high sulfur-blended rubber to the low sulfur-blended rubber particularly in vulcanization, and a larger blend amount of sulfur than a set blend amount thereof is present in the low sulfur-blended rubber in the vicinity of an interface thereto. As a result thereof, a balance of a cross-linking agent is broken in the vicinity of the interface, and characteristics which are initially expected can not be exhibited. Accordingly, an amount of sulfur after it is transferred to the low sulfur concentration rubber composition side is estimated to blend zinc oxide which is a vulcanization accelerating agent satisfying the condition shown in the equation (I) described above and the antioxidant and/or the naphthoic hydrazide compound satisfying the condition shown in the equation (II) described above in advance into the low sulfur concentration rubber composition, whereby the balance described above is obtained; a difference produced between characteristics in a central part of the members in the composite and characteristics in the vicinity of an interface to other adjacent members is controlled; and a reduction in the curability, particularly growth of cracks can be inhibited.

Further, a blending amount of zinc oxide based on 100 parts by mass of the rubber component in the low sulfur concentration rubber composition described above is set preferably to an amount satisfying a condition shown in the following equation (III), and a blending amount of the antioxidant and/or the naphthoic hydrazide compound is set preferably to an amount satisfying a condition shown in the following equation (IV):

blending amount (parts by mass) of zinc oxide in the low sulfur concentration rubber composition≧Sb×1.5+(Sa−Sb)×0.5 (III)

(wherein Sa and Sb represent the same contents as described in the equation (I)) and

blending amount (mole) of the antioxidant and/or the naphthoic hydrazide compound in the low sulfur concentration rubber composition>0.005+(Sa−Sb)/1000 (IV)

(wherein Sa and Sb represent the same contents as described in the equation (I)).

An upper limit of the concentration difference of sulfur described above shall not specifically be restricted, and it is usually about 10 parts by mass.

Further, an upper limit of a blending amount of zinc oxide which is obtained according to the equations (I) and (III) shall not specifically be restricted, and it is usually about 10 parts by mass based on 100 parts by mass of the rubber component.

Also, an upper limit of a blending amount of the antioxidant and/or the naphthoic hydrazide compound which is obtained according to the equations (II) and (IV) shall not specifically be restricted, and it is usually about 2×10⁻² mole based on 100 parts by mass of the rubber component.

The diene base rubber constituting the rubber composition according to the present invention includes polyisoprene rubbers such as natural rubbers, synthetic polyisoprene rubbers and the like, polybutadiene rubbers, styrene-butadiene copolymer rubbers and the like. The polyisoprene rubbers are preferred, and the natural rubbers are particularly preferred. Also, the rubber component constituting the low sulfur concentration rubber composition described above comprises preferably polyisoprene rubber in a proportion of 50% by mass or more. The proportion is more preferably 80% by mass or more, particularly preferably 100% by mass. Controlling a use amount of polyisoprene in the range described above makes it possible to sufficiently obtain the targeted effects without allowing the effects thereof to the rubber chemicals such as zinc oxide and the antioxidant and/or the naphthoic hydrazide compound to be restricted.

The antioxidant and/or the naphthoic hydrazide compound blended into the low sulfur concentration rubber composition described above shall not specifically be restricted, and amine base antioxidants, phenol base antioxidants, derivatives of 3-hydroxy-2-naphthoic hydrazide (HNH) and derivatives of 1-hydroxy-2-naphthoic hydrazide can be used. At least 50% by mass of the antioxidant and/or the naphthoic hydrazide compound is preferably the amine base antioxidant and/or the derivative of 3-hydroxy-2-naphthoic hydrazide (HNH). A blending amount of the antioxidant and/or the naphthoic hydrazide compound described above based on 100 parts by mass of the rubber component in the low sulfur concentration rubber composition is limited by the equation (II) or the equation (IV) described above, and it is usually 1.0×10⁻³ mole to 2.0×10⁻² mole.

The amine base antioxidants shall not specifically be restricted and include amine-ketone base antioxidants such as 2,2,4-trimethyl-1,2-dihydroquinoline polymers, 6-ethoxy-1,2-dihydro-2,2,4-trimethylquinoline and reaction products of diphenylamine with acetone; aromatic secondary amine base antioxidants such as phenyl-1-naphthylamine, alkylated diphenylamine, octylated diphenylamine, 4,4′-bis(α,α-dimethylbenzyl)diphenylamine, p-(p-toluenesulfonylamide)diphenylamine, N,N′-di-2-naphthyl-p-phenylenediamine, N,N′-diphenyl-p-phenylenediamine, N-phenyl-N′-isopropyl-p-phenylenediamine, N-(1,3-dimethylbutyl)-N′-phenyl-p-phenylenediamine, N-phenyl-N′-(3-methacryloyloxy-2-hydroxypropyl)-p-phenylenediamine and the like; and monophenol base antioxidants such as 2,6-di-tert-butyl-4-methylphenol, 2,6-di-tert-butyl-4-ethylphenol, mono(or di or tri)(α-methylbenzyl)phenol and the like. Among them, the aromatic secondary amine base antioxidant which is excellent in a crack growth potential resistance, for example, N-(1,3-dimethylbutyl)-N′-phenyl-p-phenylenediamine is preferred. The above amine base antioxidants may be used alone or in combination of two or more kinds thereof.

Also, the naphthoic hydrazide compound has an effect of reducing vulcanization return and an effect of reducing the heat generating property.

The naphthoic hydrazide compound includes, for example, the derivatives of 3-hydroxy-2-naphthoic hydrazide (HNH) and the derivatives of 1-hydroxy-2-naphthoic hydrazide. The derivatives of 3-hydroxy-2-naphthoic hydrazide (HNH) include, for example, 3-hydroxy-2-naphthoic hydrazides such as 3-hydroxy-2-naphthoic (1-methylethylidene) hydrazide, 3-hydroxy-2-naphthoic (1-methylpropylidene) hydrazide, 3-hydroxy-2-naphthoic (1,3-dimethylpropylidene) hydrazide, 3-hydroxy-2-naphthoic (1-phenylethylidene) hydrazide and the like. Among them, 3-hydroxy-N′-(1,3-dimethylethylidene)-2-naphthoic hydrazide (BMH) which is the derivative of 3-hydroxy-2-naphthoic hydrazide (HNH) is particularly preferred since it is markedly effective.

The above naphthoic hydrazide compounds may be used alone or in combination of two or more kinds thereof, and they can be used in combination with the antioxidants described above.

In the present invention, a blending amount of carbon black which is a reinforcing filler constituting the low sulfur concentration rubber composition described above is preferably 50 parts by mass or less based on 100 parts by mass of the rubber component. It is more preferably 30 to 45 parts by mass.

Controlling a use amount of carbon black in the range described above decreases restriction thereof to the rubber chemicals such as the effects of zinc oxide and the antioxidant and/or the naphthoic hydrazide compound and makes it possible to sufficiently exhibit the targeted effects.

The kind of carbon black shall not specifically be restricted and includes, for example, FEF, HAF, ISAF, SAF and the like.

When the composite of the present invention is used as a member for a tire, it is particularly preferably used as a member which is not brought into direct contact with the ambient air since the effects of the above composite can effectively be put to practical use.

When the composite described above, particularly the low sulfur concentration rubber composition is used as a member which is brought into direct contact with the ambient air, an effect of a reduction in the physical properties brought about by oxidative degradation is exerted to a large extent, and the effects of the present invention are relatively reduced.

In addition to the various components described above, components such as stearic acid, a softening agent, a vulcanization accelerating aid, a wax and the like which are used usually in the rubber industry as long as the effects of the present invention are not damaged can suitably be blended into the low sulfur concentration rubber composition and the high sulfur concentration rubber composition which are used for the rubber composite of the present invention.

These rubber compositions are obtained by kneading by means of a kneading machine such as a roll, an internal mixer, a Banbury mixer and the like and turned into composites by a conventional method, and they are vulcanized after subjected to building and working and are used in the form of a composite of a steel cord coating rubber member which is the high sulfur concentration rubber composition in the tire of the present invention for a heavy load with a rubber member which is the low sulfur concentration rubber composition adjacent thereto.

According to the present invention, capable of being provided are a rubber composite improved in a problem originating in a difference in a concentration of a blending agent, particularly sulfur between adjacent rubber compositions comprising a rubber composition cross-linked by sulfur without using new raw materials and members and a tire prepared by using the same.

### EXAMPLES

Next, the present invention shall be explained in further details with reference to examples, but the present invention shall by no means be restricted by these examples.

Various measurements in the respective examples and comparative examples were carried out by the following methods.

### Examples 1 to 5, Comparative Examples 1 to 5 and Reference Example 1

### Preparation of Composites

High sulfur concentration-blended and low sulfur concentration-blended rubber compositions were prepared based on blend compositions shown in Table 1 according to an ordinary method, and the respective rubber sheets (thickness: 20 mm) were prepared according to combinations of the high sulfur concentration-blended and low sulfur concentration-blended rubber compositions shown in Table 2. Then, they were stuck together and vulcanized at 130° C. for 240 minutes to obtain the respective rubber composites.

### <Evaluation of the Composites>

The rubber composites thus prepared were subjected to an aging test on the conditions of 80° C. and 20 days in a nitrogen atmosphere.

The sample after the aging test was sliced parallel to a stuck surface, and samples were punched out from the sliced rubber (thickness: 1.5 mm) at portions apart by 1 mm and 15 mm from an interface in the low sulfur concentration-blended rubber composition to determine a cutting tensile stress (hereinafter referred to as TSb) based on JIS K 6521:2004. The sample obtained at the portion apart by 1 mm from the interface was referred to as “vicinity of interface”, and the sample obtained at the portion apart by 15 mm from the interface was referred to as “inside”.

The cutting tensile stresses before aging and after aging are shown by an index, wherein TSb of “inside” in the respective samples is set as 100, and a ratio of TSb of “vicinity of interface” thereto is determined. A larger difference between the respective numerical values shows that a difference between TSb in a central part of the member in the rubber composite and TSb in the vicinity of an interface to other adjacent members is larger. The evaluation results thereof are shown in Table 2.

TABLE 1

| | High | High | Low | Low | Low | Low | Low | Low | Low | Low | Low |
|---|---|---|---|---|---|---|---|---|---|---|---|
| | sulfur | sulfur | sulfur | sulfur | sulfur | sulfur | sulfur | sulfur | sulfur | sulfur | sulfur |
| | concen- | concen- | concen- | concen- | concen- | concen- | concen- | concen- | concen- | concen- | concen- |
| Rubber composition | tration | tration | tration | tration | tration | tration | tration | tration | tration | tration | tration |
| No. | blend 1 | blend 2 | blend 1 | blend 2 | blend 3 | blend 4 | blend 5 | blend 6 | blend 7 | blend 8 | blend 9 |
| Natural rubber*¹ | 100 | 100 | 100 | 100 | 100 | 100 | 100 | 100 | 100 | 100 | 100 |
| (mass part) | | | | | | | | | | | |
| Carbon black*² | 50 | 50 | 40 | 40 | 40 | 40 | 40 | 40 | 40 | 55 | 55 |
| (mass part) | | | | | | | | | | | |
| Antioxidant 6PPD*³ | 1 | 1 | 1 | 1 | 1 | 1 | 2 | 1.5 | 3 | 2 | 1 |
| (mass part) | | | | | | | | | | | |
| Antioxidant 6PPD | — | — | 0.0037 | 0.0037 | 0.0037 | 0.0037 | 0.0075 | 0.0056 | 0.0111 | 0.0075 | 0.0037 |
| (mole) | | | | | | | | | | | |
| Naphthoic hydrazide*⁴ | — | — | — | — | — | — | — | 1 | — | — | — |
| (mass part) | | | | | | | | | | | |
| Naphthoic hydrazide | — | — | — | — | — | — | — | 0.0035 | — | — | — |
| (mole) | | | | | | | | | | | |
| Stearic acid | 1 | 1 | 2 | 2 | 2 | 2 | 2 | 2 | 2 | 2 | 2 |
| (mass part) | | | | | | | | | | | |
| Zinc oxide | 5 | 5 | 3 | 3 | 5 | 7 | 5 | 5 | 5 | 5 | 5 |
| (mass part) | | | | | | | | | | | |
| Vulcanization | 0.6 | 0.6 | 0.8 | 0.8 | 0.8 | 0.8 | 0.8 | 0.8 | 0.8 | 0.8 | 0.8 |
| accelerating agent*⁵ | | | | | | | | | | | |
| (mass part) | | | | | | | | | | | |
| Sulfur (mass part) | 6 | 4 | 2 | 3 | 2 | 2 | 2 | 2 | 2 | 2 | 2 |

Remarks:
^{*1}Natural rubber RSS #3
^{*2}Carbon black N330
^{*3}Amine base antioxidant “SANTOFLEX 6PPD”, manufactured by FLEXSIS Inc.; a mole value was calculated from a gram value of blended parts by mass based on 100 parts by mass of the rubber component assuming that a molecular weight was 268.4
^{*4}naphthoic hydrazide: 3-hydroxy-N′-(1,3-dimethylbutylidene)-2-naphthoic hydrazide; a mole value was calculated from a gram value of blended parts by mass based on 100 parts by mass of the rubber component assuming that a molecular weight was 284.4
^{*5}Vulcanization accelerating agent: N,N-dicyclohexyl-2-benzothiazylsulfeneamide, trade name “Nocceler DZ-G”, manufactured by Ouchi Shinko Chemical Industrial Co., Ltd.

TABLE 2

| | | | Comparative Example | | | | Example | |
|---|---|---|---|---|---|---|---|---|
| | | | 1 | 2 | 3 | 4 | 1 | 2 |
| Rubber composite | High sulfur concentration blend | | 1 | 1 | 1 | 1 | 1 | 1 |
| (combination) | Composition No. | | | | | | | |
| | Low sulfur concentration blend | | 1 | 2 | 3 | 4 | 5 | 6 |
| | Composition No. | | | | | | | |
| Difference in sulfur concentration between high sulfur | | | 4 | 3 | 4 | 4 | 4 | 4 |
| concentration blend and low sulfur concentration blend | | | | | | | | |
| (mass part) | | | | | | | | |
| Zinc oxide mass part: | | >Sb × 1.3 + (Sa − | 3.8 | 4.8 | 3.8 | 3.8 | 3.8 | 3.8 |
| equation (I) | | Sb) × 0.3 | | | | | | |

| | | | | | | | |
|---|---|---|---|---|---|---|---|
| Blend amount (mass part) of | | 3 | 3 | 5 | 7 | 5 | 5 |
| zinc oxide | | | | | | | |
| Antioxidant and/or naphthoic | >0.005 + (Sa − | 0.0070 | 0.0065 | 0.0070 | 0.0070 | 0.0070 | 0.0070 |
| hydrazide (mole): equation (II) | Sb)/2000 | | | | | | |
| Antioxidant and/or naphthoic | | 0.0037 | 0.0037 | 0.0037 | 0.0037 | 0.0075 | 0.0091 |
| hydrazide blend amount (mole) | | | | | | | |
| Zinc oxide mass part: | ≧Sb × 1.5 + (Sa − | 5 | 6 | 5 | 5 | 5 | 5 |
| equation (III) | Sb) × 0.5 | | | | | | |
| Blend amount (mass part) of | | 3 | 3 | 5 | 7 | 5 | 5 |
| zinc oxide | | | | | | | |
| Antioxidant and/or naphthoic | >0.005 + (Sa − | 0.0090 | 0.0080 | 0.0090 | 0.0090 | 0.0090 | 0.0090 |
| hydrazide (mole): equation (IV) | Sb)/1000 | | | | | | |
| Antioxidant and/or naphthoic | | 0.0037 | 0.0037 | 0.0037 | 0.0037 | 0.0075 | 0.0091 |
| hydrazide blend amount (mole) | | | | | | | |
| Cutting tensile stress (TSb) | Inside | 100 | 100 | 100 | 100 | 100 | 100 |
| before aging test | Vicinity of | 96 | 96 | 96 | 97 | 97 | 97 |
| | interface (INDEX) | | | | | | |
| Cutting tensile stress (TSb) | Inside | 100 | 100 | 100 | 100 | 100 | 100 |
| after aging test | Vicinity of | 83 | 84 | 85 | 86 | 88 | 92 |
| | interface (INDEX) | | | | | | |

| | | | | | Reference | | Comparative |
|---|---|---|---|---|---|---|---|
| | | | Example | | Example | Example | Example |
| | | | 3 | 4 | 1 | 5 | 5 |
| Rubber composite | High sulfur concentration blend | | 1 | 1 | 2 | 2 | 1 |
| (combination) | Composition No. | | | | | | |
| | Low sulfur concentration blend | | 7 | 8 | 2 | 7 | 9 |
| | Composition No. | | | | | | |
| Difference in sulfur concentration between high sulfur | | | 4 | 4 | 1 | 2 | 4 |
| concentration blend and low sulfur concentration blend | | | | | | | |
| (mass part) | | | | | | | |
| Zinc oxide mass part: | | >Sb × 1.3 + (Sa − | 3.8 | 3.8 | 4.2 | 3.2 | 3.8 |
| equation (I) | | Sb) × 0.3 | | | | | |

| | | | | | | |
|---|---|---|---|---|---|---|
| Blend amount (mass part) of | | 5 | 5 | 3 | 5 | 5 |
| zinc oxide | | | | | | |
| Antioxidant and/or naphthoic | >0.005 + (Sa − | 0.0070 | 0.0070 | 0.0055 | 0.0060 | 0.0070 |
| hydrazide (mole): equation (II) | Sb)/2000 | | | | | |
| Antioxidant and/or naphthoic | | 0.0112 | 0.0075 | 0.0037 | 0.0112 | 0.0037 |
| hydrazide blend amount (mole) | | | | | | |
| Zinc oxide mass part: | ≧Sb × 1.5 + (Sa − | 5 | 5 | 5 | 4 | 5 |
| equation (III) | Sb) × 0.5 | | | | | |
| Blend amount (mass part) of | | 5 | 5 | 3 | 5 | 5 |
| zinc oxide | | | | | | |
| Antioxidant and/or naphthoic | >0.005 + (Sa − | 0.0090 | 0.0090 | 0.0060 | 0.0070 | 0.0090 |
| hydrazide (mole): equation (IV) | Sb)/1000 | | | | | |
| Antioxidant and/or naphthoic | | 0.0112 | 0.0075 | 0.0037 | 0.0112 | 0.0037 |
| hydrazide blend amount (mole) | | | | | | |
| Cutting tensile stress (TSb) | Inside | 100 | 100 | 100 | 100 | 100 |
| before aging test | Vicinity of | 97 | 96 | 98 | 98 | 95 |
| | interface (INDEX) | | | | | |
| Cutting tensile stress (TSb) | Inside | 100 | 100 | 100 | 100 | 100 |
| after aging test | Vicinity of | 91 | 89 | 99 | 93 | 87 |
| | interface (INDEX) | | | | | |

The following can be found from Table 2.

It can be found that in Examples 1 to 5 of the present invention, the indices of the cutting tensile stresses (TSb) after the aging test are improved as compared with those in Comparative Examples 1 to 5 and that they are improved in an order of the composites satisfying the requisites (I) and (II) described above at the same time and the composites satisfying the requisites (III) and (IV) described above at the same time.

It can be found that in the composite prepared in Reference Examples 1, a difference in a concentration of sulfur contained in the rubber composition blended with high concentration sulfur and the rubber composition blended with low concentration sulfur is as small as 1 part by mass and that the cutting tensile stress (TSb) after the aging test is as high as 99, and It can be found that in Example 7, the index described above is improved to 93.

### INDUSTRIAL APPLICABILITY

The present invention can provide a rubber composite improved in a problem originating in a difference in a concentration of a blending agent, particularly sulfur between adjacent rubber compositions comprising a rubber composition cross-linked by sulfur without using new raw materials and members and a tire prepared by using the same.

In particular, the present invention can be applied to tires for a heavy load in the form of a composite of a steel cord coating rubber member which is a high sulfur concentration rubber composition and a rubber member which is a low sulfur concentration rubber composition adjacent thereto.

1. A rubber composite constituted of at least two layers of members comprising a rubber composition containing a diene base rubber cross-linked by sulfur, wherein a difference in a concentration of sulfur between adjacent members in the rubber composite described above is 1.5 part by mass or more based on 100 parts by mass of a rubber component in the rubber composition described above; zinc oxide is blended in an amount satisfying a condition shown in the following equation (I) based on 100 parts by mass of a rubber component in a low sulfur concentration rubber composition among the adjacent members, and an antioxidant and/or a naphthoic hydrazide compound are blended in an amount satisfying a condition shown in the following equation (II) based on 100 parts by mass of the rubber component in the low sulfur concentration rubber composition:
blending amount (parts by mass) of zinc oxide in the low sulfur concentration rubber composition>Sb×1.3+(Sa−Sb)×0.3 (I)
(wherein Sa represents a blending amount (parts by mass) of sulfur in the high sulfur concentration rubber composition, and Sb represents a blending amount (parts by mass) of sulfur in the low sulfur concentration rubber composition) and
blending amount (mole) of the antioxidant and/or the naphthoic hydrazide compound in the low sulfur concentration rubber composition>0.005+(Sa−Sb)/2000 (II)
(wherein Sa and Sb represent the same contents as described in the equation (I)).

2. The rubber composite according to claim 1, wherein a blending amount of zinc oxide based on 100 parts by mass of the rubber component in the low sulfur concentration rubber composition described above is an amount satisfying a condition shown in the following equation (III), and a blending amount of the antioxidant and/or the naphthoic hydrazide compound is an amount satisfying a condition shown in the following equation (IV):
blending amount (parts by mass) of zinc oxide in the low sulfur concentration rubber composition≧Sb×1.5+(Sa−Sb)×0.5 (III)
(wherein Sa and Sb represent the same contents as described in the equation (I)) and
blending amount (mole) of the antioxidant and/or the naphthoic hydrazide compound in the low sulfur concentration rubber composition>0.005+(Sa−Sb)/1000 (IV)
(wherein Sa and Sb represent the same contents as described in the equation (I)).

3. The rubber composite according to claim 1, wherein at least 50% by mass of the antioxidant and/or the naphthoic hydrazide compound blended into the low sulfur concentration rubber composition is an amine base antioxidant and/or a derivative of 3-hydroxy-2-naphthoic hydrazide.

4. The rubber composite according to claim 1, wherein at least 50% by mass of the rubber component constituting the low sulfur concentration rubber composition is polyisoprene.

5. The rubber composite according to claim 1, wherein a blending amount of carbon black which is a reinforcing filler constituting the low sulfur concentration rubber composition is 50 parts by mass or less based on 100 parts by mass of the rubber component.

6. A tire characterized by using the rubber composite according to any of claims 1 to 5 as a member which is not brought into direct contact with the ambient air.

7. The tire according to claim 6, wherein it is a tire for a heavy load.
